(19) United States
(12) Patent Application Publication
(10) Pub. No.: US 2005/0076090 A1
(43) Pub. Date: Apr. 7, 2005

(54) Method, system, and apparatus for selective automated electronic mail replies

(75) Inventor: Keith A. Thuerk, Southlake, TX (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/680,045

(22) Filed: Oct. 7, 2003

(51) Int. Cl. G06F 15/16

(52) U.S. Cl. 709/207

(57) ABSTRACT

A method of communicating over a communications network can include the steps of defining a list specifying at least one electronic message source to which automated reply electronic messages are allowed and receiving an electronic message from a source. The source of the received electronic message can be compared with the source on the list and an automated reply electronic message can be sent to the source of the received electronic message if the source matches the source on the list.

### BACKGROUND

1. Field of the Invention

This invention relates to the field of electronic communications systems and, more particularly to preventing unwanted incoming electronic messages.

2. Description of the Related Art

Electronic mail (e-mail) and other electronic messaging systems, including instant messaging, have become essential tools for modern communication. Users have come to rely on such systems as a primary means of communication with co-workers and social contacts alike. This increased reliance has led to the development of features that attempt to make electronic communications even more dependable. One such feature is the automated reply, or auto-reply function within e-mail systems. Conventional e-mail systems can be instructed to respond automatically to incoming e-mails using a programmed message. Typically, this feature allows a receiving e-mail system to confirm receipt of an e-mail, while also informing the sender that the user will be unavailable for a period of time.

The unsolicited e-mail industry, or so called “spam” industry, has experienced significant growth, paralleling that of e-mail itself. Valid e-mail addresses are valuable commodities within the spam industry as each e-mail address represents a potential customer. Spammers attempt to maximize unsolicited e-mail sent to valid e-mail addresses and minimize the e-mail sent to invalid e-mail addresses in an effort to conserve resources and increase profitability. E-mail addresses, however, can be easily changed and frequently modified, deleted, or created. As a result, it can be difficult for spammers to maintain a current list of valid e-mail addresses.

One way in which spammers check the validity of an e-mail and other network addresses is by monitoring for a response to an unsolicited e-mail. Many unsolicited e-mails invite the recipient to select a hyperlink or send a reply e-mail to a particular address to either obtain more information, purchase a product, or to be removed from the spammer's solicitation list. When a response is received, the spammer affirms the validity of the responder's e-mail address.

When a user invokes an auto-reply function, for example while the user is on vacation, the e-mail system responds to any received e-mails using an automatically generated, programmed message. The auto-reply function remains active for the duration specified by the user or administrator, or until deactivated. If a received e-mail is an unsolicited e-mail or considered to be spam, a reply sent from the recipient serves only to confirm the validity of the recipient's e-mail address to the spammer. Typically, this means that the recipient can look forward to receiving additional unsolicited e-mail from the same source or spammer.

### SUMMARY OF THE INVENTION

The present invention provides a solution for limiting the amount of unsolicited electronic messages, whether electronic mail messages (e-mail), instant messages, or any other type of electronic message, received by users. According to the present invention, users can invoke an automated reply feature within an electronic communication system. A list is developed that specifies one or more allowable sources of electronic messages, whether entire domains, individual addresses, groups of address, or the like, to which automated replies can be sent. Thus, when the automated reply feature is invoked, automated replies are sent only in response to received electronic messages from sources specified in the list of allowable sources of electronic messages.

One aspect of the present invention can include a method of communicating over a communications network. The method can include defining a list specifying at least one electronic message source to which automated reply electronic messages are allowed, receiving an electronic message from a source, comparing the source of the received electronic message with a source on the list, and sending an automated reply electronic message to the source of the received electronic message if the source matches the source on the list. The electronic message can be an e-mail or an instant message.

The method further can include the step of activating an auto-reply function in an electronic communication system. The electronic message source can be a domain, or one or more electronic message addresses. Still, the electronic message source can specify that an automated reply electronic message can be sent to any electronic message address listed in a personal address book.

Another aspect of the present invention can include an electronic communication system configured to selectively provide automated reply electronic messages in response to received electronic messages. The electronic communication system can be configured to only send automated reply electronic messages to sources of the received electronic messages that match a list specifying approved electronic message sources. The electronic communication system can be implemented as a client, a server, or as a server and one or more clients. The electronic communication system also can include one or more data stores including the list specifying approved electronic mail sources.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for providing automated reply messages, whether electronic mail messages or instant messages, in accordance with one embodiment of the inventive arrangements disclosed herein.

FIG. 2 is a schematic diagram illustrating one embodiment of a graphical user interface for use with the system of FIG. 1.

FIG. 3 is a flow chart illustrating a method of automatically responding to messages in accordance with one embodiment of the inventive arrangements disclosed herein.

### DETAILED DESCRIPTION OF THE INVENTION

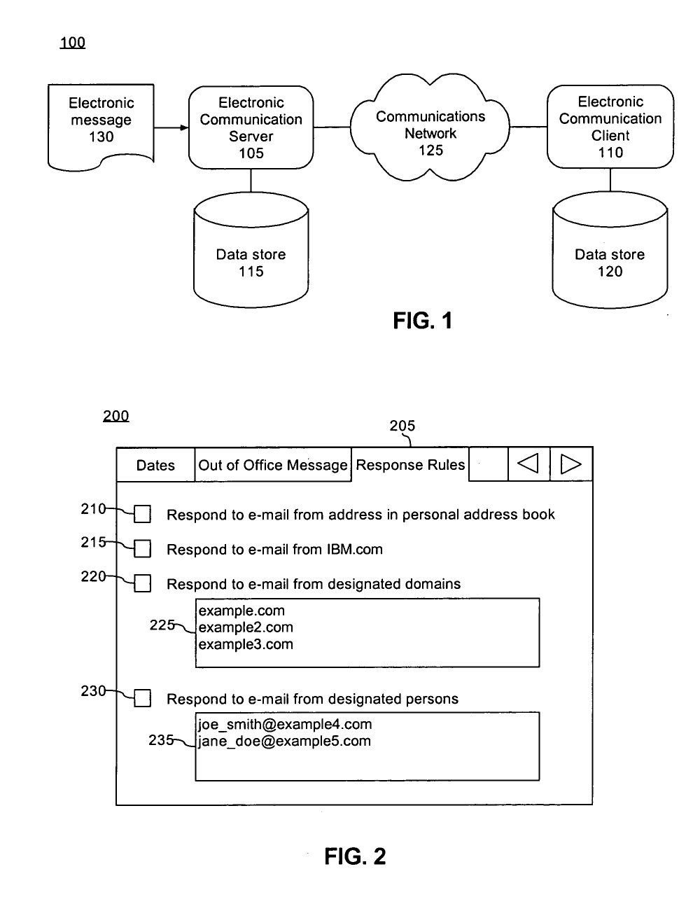

FIG. 1 is a schematic diagram illustrating a system 100 for providing automated reply electronic messages, whether electronic mail messages (e-mails) or instant messages, in accordance with one embodiment of the inventive arrangements disclosed herein. As shown, the system 100 can include an electronic communication server (server) 105, an electronic communication client (client) 110, various data stores 115 and 120, and a communications network 125.

The server 105 can be a software program disposed within an information processing system. The server 105 is configured to send electronic messages (messages) to, receive messages from, and route messages between other networks (not shown) or one or more clients such as client 110. The server 105 is communicatively linked with the communication network 125, whether via wired connection or a wireless connection. The communications network 125 can be implemented as the Internet, an intranet, a local area network (LAN), a wide area network (WAN), or any other suitable network over which messages, such as e-mails, instant messages, or the like, can be exchanged.

The client 110, like the server 105, can be an application program executing within an information processing system that is communicatively linked with the communications network 125, whether via wired or wireless connections. Accordingly, the client 110 and the server 105 can communicate and exchange messages as well as other information.

The server 105 and the client 110 each can include, or be communicatively linked with, a data store. For example, server 105 can be associated with data store 115 and client 110 can be associated with data store 120. Each data store can include a listing, or a set of rules, that define particular message addresses, groups of message addresses, and/or domains (hereafter sources). Each listing specifies sources of messages to which automated reply messages can be sent.

According to one embodiment of the present invention, a user can define a listing of approved sources to which automated reply messages can be sent within data store 120. Data store 115 also can include such a listing. The listing in data store 115, however, can be defined by a system administrator. Further, data store 115 can include one or more rules specifying which listing of rules dominates in the event of a conflict.

In operation, a message 130 can be received by the server 105. The server 105 can determine that the intended destination of received message 130 is client 110. Accordingly, the message 130 can be forwarded to the client 110, or can be stored in the server 105 until such time that the client 110 retrieves the message 130.

The client 110 can be configured to provide an automated reply message responsive to receiving selected messages. Upon receiving the message 130, the client 110 can first check whether the source of message 130 matches a source within the list of approved sources in the data store 120. If the source of message 130 matches an approved source, then the automated reply message can be sent. If not, no automated reply message is sent.

It should be appreciated that the system 100 can be implemented in any of a variety of different configurations. For example, the present invention can be implemented within Lotus Notes, from International Business Machines Corporation of Armonk, N.Y. The inventive arrangements disclosed herein, however, are not to be limited by the particular communication system in which the invention is implemented.

For example, in one embodiment, the client 110 can make determinations as to whether an automated reply message should be sent responsive to a received message. Alternatively, the server 105 can make such determinations. In that case, for example, a user can define a list of approved sources of messages via the client 110 and upload the list to the server 105. The client 110, when so configured, can generate automated reply messages which can be selectively forwarded by the server 105 based upon the uploaded list from client 110.

In yet another embodiment, both the server 105 and the client 110 can include lists of approved sources of messages, for example within data stores 115 and 120. While the server 105 and the client 110 each can include rules, it should be appreciated that the client 110 also can be configured to upload rules to the server 105 in such an embodiment. A system administrator further can specify rules within the administrative list which specify which set of rules, or which list, either the server 105 or the client 110, dominates the other and in what situations. For example, an administrator can specify that any received e-mails from within the organization, i.e. those e-mails having the same domain as the recipient, can receive automated reply e-mails. Further, the server 105 rules can override any user settings which attempt to exclude particular persons at the same domain from receiving automated reply e-mails.

In any case, it should be appreciated that the particular hierarchy of rules, whether specified in the server 105, the client 110, or both, can be completely configurable. Additionally, the particular implementation of system 100 can depend upon the size of the organization and electronic communication system used by that organization.

FIG. 2 is a schematic diagram illustrating one embodiment of a graphical user interface (GUI) 200 for use with the client and/or server of FIG. 1. The GUI 200 can be presented, by the server and/or client, to a user or an administrator when a request is received to invoke an auto-reply function. As is known in the art, conventional electronic communication systems permit users to specify time periods in which reply messages are automatically sent in response to received messages. The automated reply message is sent to the source or sending address of the received message.

The GUI 200 can include one or more portions within which information can be added specifying the time in which automated reply messages are to be sent, as well as the particular text, sound, and/or graphics to be included in the automated reply message. The GUI 200 can include an additional portion, in this case a tab 205 labeled “Response Rules” within which a user or administrator can specify sources to which automated response messages can be sent.

As shown, the GUI 200 can include a control 210 for specifying that only electronic mails originating from addresses listed in the recipient's own address book, whether stored locally or in a remote and network accessible data store, are to be sent automated response messages. Activation of control 215 specifies that automated response messages are to be sent responsive to messages that are received and originate from within the same domain as the user, in this case any message including the “IBM.com” domain.

Activation of control 220 can activate data field 225 for receiving one or more other approved domains. Thus, if messages are received from the domains “example1.com”, “example2.com”, and “example3.com” specified in data field 225, an automated reply message will be generated and sent to the sender, presuming the automated reply function has been activated. Accordingly, automated reply messages can be sent selectively, on a domain by domain basis, without regard to the username portion of an address that precedes the domain name.

Activation of control 230 activates data field 235 in which individual electronic address can be entered. As shown, the electronic communication system will send an automated reply message responsive to receiving a message originating from “joe_smith@example4.com” or “jane_doe@example5.com”.

In another embodiment, the rules or an automated reply list can include portions of addresses and/or domains in addition to wildcards and other common search operators. Accordingly, portions of the source of a received message can be compared with rules specifying particular characters, text, or words. An automated response message can be sent in the event of a match.

While not illustrated in FIG. 200, it should be appreciated that additional groupings and categorizations of sources, whether domains or addresses, also can be specified. For example, users and/or administrators can specify groups of approved persons, similar to groupings used in a contact management application. Such an embodiment would permit a user to define and add personal contacts to an approved response list, business contacts, medical service providers, or the like. Still, predetermined groups within a business entity can be used. For example, management, or those included in a management list, can be added to the approved list while technical persons, or those persons included in a technical personnel list, are excluded from such a list.

The GUI 200 depicted in FIG. 2 has been provided for purposes of illustration only. It should be appreciated by those skilled in the art that such a GUI can be implemented in a variety of different configurations using an assortment of control mechanisms. As such, the GUI 200 is not intended as a limitation of the present invention. Further, while the GUI 200 is for use with an e-mail system, it should be appreciated that a similar GUI can be used with reference to an instant messaging system or other types of electronic messaging systems.

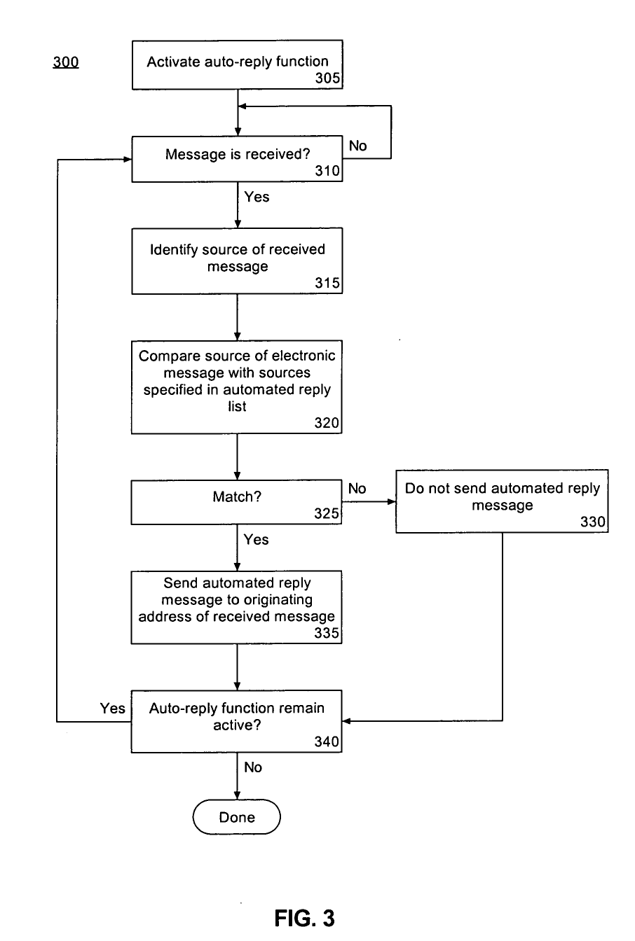

FIG. 3 is a flow chart illustrating a method 300 of automatically responding to messages, such as e-mails or instant messages, in accordance with one embodiment of the present invention. The method 300 can begin in a state where a user and/or system administrator has configured an auto-reply function within a communication system. One or more rules, or a list, specifying allowable addresses and/or domains to which automated reply messages can be sent also can be defined. Accordingly, in step 305, the auto-reply function within the electronic communication system can be activated, whether in the client or server portion of the system. The auto-reply function can be activated responsive to a user and/or system administrator request.

In step 310, a determination can be made as to whether a message has been received. If so, the method can continue to step 315. If not, the method can loop back to continue monitoring for a received message until such time that one is received. In step 315, the source, that is the address or domain, of the received message is identified.

In step 320, the source can be compared with the sources specified in an automated reply list, whether disposed in a communication system server, a client, both the server and client, or one or more remote data stores. That is the source address and/or domain of the received message can be compared with any addresses, domains, or other rules specifying portions of source addresses or domains contained in an automated reply list. In step 325, if no match is determined, the method can proceed to step 330. If a match is determined, the method can continue to step 335, where an automated reply message is sent to the originating or source address of the received message.

In step 330, in the case where no match is determined, the communication system can refrain from sending and/or generating an automated reply message to the originating address of the received message. As noted, in one embodiment of the present invention, no automated reply message is generated, for example by the communication system client. In another embodiment, the client can generate and send an automated reply message, however, the server can intercept the automated reply message and delete and/or refrain from forwarding it to the recipient or originating address.

In any case, in step 340, the user's configuration information pertaining to the auto-reply function can be consulted to determine whether the auto-reply function is to remain active. If so, the method can proceed to step 310 to repeat as may be required. If not, the method can end.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises' all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of communicating over a communications network comprising the steps of:
defining a list specifying at least one electronic message source to which automated reply electronic messages are allowed;
receiving an electronic message from a source;
comparing the source of the received electronic message with the source in the list; and
sending an automated reply electronic message to the source of the received electronic message if the source matches the source on the list.

2. The method of claim 1, wherein the electronic message is an electronic mail message.

3. The method of claim 1, wherein the electronic message is an instant message.

4. The method of claim 1, further comprising the step of activating an auto-reply function in an electronic communication system.

5. The method of claim 1, wherein the electronic message source is a domain.

6. The method of claim 1, wherein the electronic message source is an electronic message address to which an automated reply electronic message can be sent.

7. The method of claim 1, wherein the electronic message source specifies that an automated reply electronic message can be sent to any electronic message address listed in a personal address book.

8. A machine readable storage, having stored thereon a computer program having a plurality of code sections executable by a machine for causing the machine to perform the steps of:
defining a list specifying at least one electronic message source to which automated reply electronic messages are allowed;
receiving an electronic message from a source;
comparing the source of the received electronic message with the source in the list; and
sending an automated reply electronic message to the source of the received electronic message if the source matches the source on the list.

9. The machine readable storage of claim 8, wherein the electronic message is an electronic mail message.

10. The machine readable storage of claim 8, wherein the electronic message is an instant message.

11. The machine readable storage of claim 8, further causing the machine to perform the step of activating an auto-reply function in an electronic communication system.

12. The machine readable storage of claim 8, wherein the electronic message source is a domain.

13. The machine readable storage of claim 8, wherein the electronic message source is an electronic message address to which an automated reply electronic message can be sent.

14. The machine readable storage of claim 8, wherein the electronic message source specifies that an automated reply electronic message can be sent to any electronic message address listed in a personal address book.

15. A system for communicating over a communications network comprising:
means for defining a list specifying at least one electronic message source to which automated reply electronic messages are allowed;
means for receiving an electronic message from a source;
means for comparing the source of the received electronic message with the source in the list; and
means for sending an automated reply electronic message to the source of the received electronic message if the source matches the source on the list.

16. The system of claim 15, further comprising means for activating an auto-reply function.

17. An electronic communication system configured to selectively provide automated reply electronic messages in response to received electronic messages, wherein said electronic communication system only sends automated reply electronic messages to sources of the received electronic messages that match a list specifying approved electronic message sources.

18. The system of claim 17, wherein said system is a client.

19. The system of claim 17, wherein said system is a server.

20. The system of claim 17, wherein said system comprises a client and a server.

21. The system of claim 17, further comprising at least one data store including the list specifying approved electronic mail sources.
